(19) United States
(12) Patent Application Publication
(10) Pub. No.: US 2017/0278007 A1
(43) Pub. Date: Sep. 28, 2017

(54) Early Warning Prediction System

(71) Applicant: NEC Laboratories America, Inc., Princeton, NJ (US)

(72) Inventors: Pranay Anchuri, Plainsboro, NJ (US); Hui Zhang, Princeton Junction, NJ (US); Guofei Jiang, Princeton, NJ (US)

(21) Appl. No.: 15/375,291

(22) Filed: Dec. 12, 2016

Related U.S. Application Data
(60) Provisional application No. 62/312,049, filed on Mar. 23, 2016.

(51) Int. Cl. G06N 7/00; G06N 99/00

(52) U.S. Cl. CPC G06N 7/005; G06N 99/005

(57) ABSTRACT

A computer-implemented method provides an early warning of an impending failure in a monitored system. The method includes performing, by a processor, an offline model learning process that generates a model of expected log rates in the monitored system from historical log data. The model represents a normal behavior of the monitored system. The method further includes performing an online detection process that detects the impending failure in the monitored system prior to an actual occurrence thereof based on (i) the model of expected log rates and (ii) observed log rates. The method also includes displaying, by a display device based on (i) the model of expected log rates and (ii) observed log rates in the monitored system, information relating to the impending failure prior to the actual occurrence of the impending failure. The online detection process identifies short term and long term failures and long term failures.

### RELATED APPLICATION INFORMATION

This application claims priority to U.S. Provisional Pat. App. Ser. No. 62/312,049 filed on Mar. 23, 2016, incorporated herein by reference in its entirety.

### BACKGROUND

Technical Field

The present invention relates to warning systems and more particularly to an early warning prediction system.

Description of the Related Art

Automated Information Technology (IT) systems include complex software with many inter-dependent components. Failures in such systems can cause financial losses, unavailability of resources, and disruption of people's daily activities. In all these system failures, the common aspect is that the failures have not been detected in a timely manner. Predicting these failures in advance would have mitigated the impact if not completely avoided. Early detection of the onset of such failures will greatly improve the reliability of IT systems and also help in the recovery from failures, by pointing out the potential root causes. Thus, there is a need for an early warning prediction system.

### SUMMARY

According to another aspect of the present invention, a computer-implemented method is provided for, in turn, providing an early warning of an impending failure in a monitored system. The method includes performing, by a processor, an offline model learning process that generates a model of expected log rates in the monitored system from historical log data. The expected log rates of the model represent a normal behavior of the monitored system. The method further includes performing, by the processor, an online detection process that detects the impending failure in the monitored system prior to an actual occurrence of the impending failure based on (i) the model of expected log rates and (ii) observed log rates in the monitored system. The method also includes displaying, by a display device based on (i) the model of expected log rates and (ii) observed log rates in the monitored system, information relating to the impending failure prior to the actual occurrence of the impending failure. The online detection process identifies short term failures and long term failures in the monitored system.

According to another aspect of the present invention, a computer program product is provided for, in turn, providing an early warning of an impending failure in a monitored system. The computer program product includes a non-transitory computer readable storage medium having program instructions embodied therewith. The program instructions are executable by a computer to cause the computer to perform a method. The method includes performing, by a processor, an offline model learning process that generates a model of expected log rates in the monitored system from historical log data. The expected log rates of the model represent a normal behavior of the monitored system. The method further includes performing, by the processor, an online detection process that detects the impending failure in the monitored system prior to an actual occurrence of the impending failure based on (i) the model of expected log rates and (ii) observed log rates in the monitored system. The method also includes displaying, by a display device based on (i) the model of expected log rates and (ii) observed log rates in the monitored system, information relating to the impending failure prior to the actual occurrence of the impending failure. The online detection process identifies short term failures and long term failures in the monitored system.

According to yet another aspect of the present invention, a computer processing system is provided for providing an early warning of an impending failure in a monitored system. The computer processing system includes a processor. The processor is configured to perform an offline model learning process that generates a model of expected log rates in the monitored system from historical log data. The expected log rates of the model represent a normal behavior of the monitored system. The processor is further configured to perform an online detection process that detects the impending failure in the monitored system prior to an actual occurrence of the impending failure based on (i) the model of expected log rates and (ii) observed log rates in the monitored system. The computer processing system additionally includes a display device, configured to display, based on (i) the model of expected log rates and (ii) observed log rates in the monitored system, information relating to the impending failure prior to the actual occurrence of the impending failure. The online detection process identifies short term failures and long term failures in the monitored system.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows a block diagram of an exemplary processing system to which the present invention may be applied, in accordance with an embodiment of the present invention;

FIG. 2 shows a block diagram of an exemplary environment to which the present invention can be applied, in accordance with an embodiment of the present invention;

FIG. 3 is a high level block/flow diagram showing an exemplary system/method for early warning prediction, in accordance with an embodiment of the present invention;

FIG. 4 is a flow diagram showing an exemplary method performed by the model updater of FIG. 3, in accordance with an embodiment of the present invention;

FIG. 5 is a flow diagram showing an exemplary method performed by the detection engine of FIG. 3, in accordance with an embodiment of the present invention;

FIG. 6 is a flow diagram further showing step 520 of the method of FIG. 5, in accordance with an embodiment of the present invention; and

FIG. 7 is a flow diagram showing an exemplary method performed by the model updater of FIG. 3, in accordance with an embodiment of the present invention.

### DETAILED DESCRIPTION OF PREFERRED EMBODIMENTS

The present invention is directed to an Early Warning Prediction System (EWPS).

In an embodiment, the present invention provides a light-weighted automatic system to detect early signals about short term and long term failures in monitored systems such as, for example, but not limited to, Internet Technology (IT) systems. In an embodiment, the present invention is placed in the domain of log analytics systems. Log messages record important events that are useful for several purposes including, but not limited to: analyzing the operational state; error diagnosis; and knowledge discovery.

In an embodiment, the present invention studies/uses the aggregated log rate behavior of a system across different scales to achieve early detection of both short term and long term failures. In an embodiment, such detection is achieved by maintaining a history of the log rate deviations. That is, the present invention uses a history of deviations to predict the early-warning signals. The main advantage is that we use a unified signal to predict both short and long term failures. Since we use aggregated log rate as the signal, the present invention allows updating on-the-fly of a model of the normal behavior of a monitored system.

It is to be appreciated that while one or more embodiments of the present invention are described with respect to an Internet Technology (IT) system, the present invention is not limited to solely IT systems and can be used with many other types of systems as readily appreciated by one of ordinary skill in the art, given the teachings of the present invention provided herein, while maintaining the spirit of the present invention. Moreover, the present invention can be readily extended to manage such systems, also as readily appreciated by one of ordinary skill in the art, given the teachings of the present invention provided herein, while maintaining the spirit of the present invention.

In an embodiment, the present invention provides a lightweight real-time solution to detect failures in systems such as, but not limited to, IT systems.

In an embodiment, the present invention can be considered to include two main components, namely an offline modeling engine and an online early warning detection engine. These two components cooperatively achieve early warning detection of short and long term failures. For example, the offline modeling engine learns the normal state behavior of the monitored system using a set of training logs. The online detection engine, after the offline models are learnt, continuously keeps track of the log rates at various scales. In real-time, the detection engine compares the log rate it's observing against the normal log rate learned during the offline modeling phase. The detection engine works by analyzing the deviations of the observed log rates (when the system is running) compared to models (learned from the training data). The detection engine reports early warning predictions if there are any statistically significant deviations.

The present invention updates the models in real-time based on the incoming stream of logs. This feature makes the present invention more robust to changes in the monitored system. This feature also helps in lowering the false positive rate of the early warning signals.

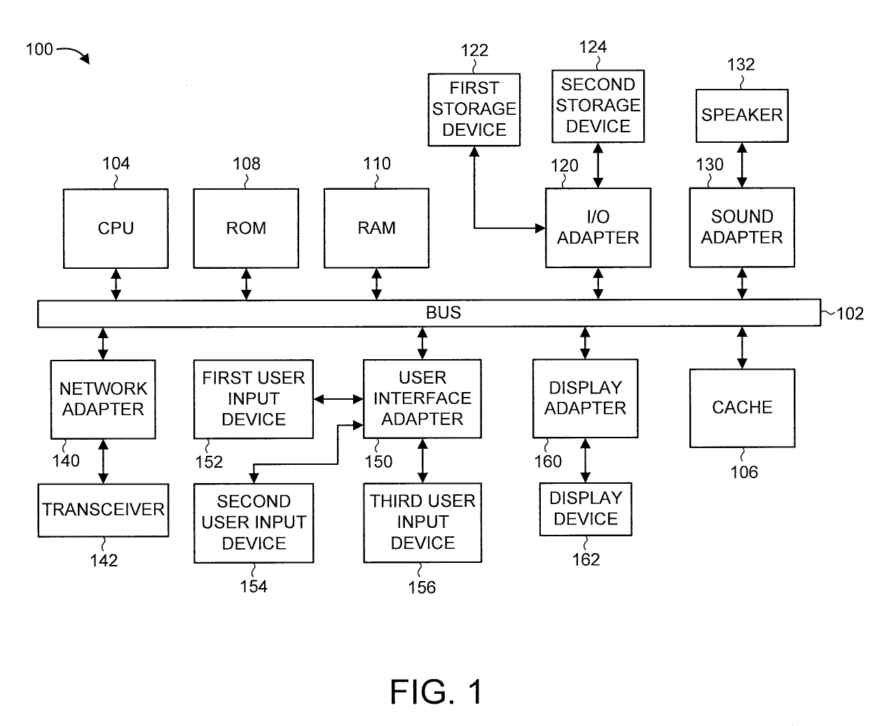

FIG. 1 is a block diagram showing an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. The speaker 132 can be used to provide an audible alarm or some other indication relating to resilient battery charging in accordance with the present invention. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

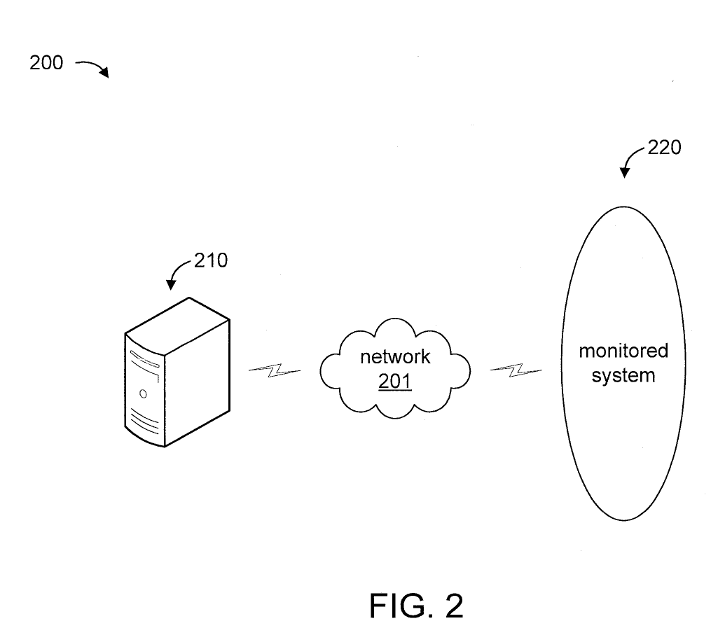

Moreover, it is to be appreciated that environment 200 described below with respect to FIG. 2 is an environment for implementing respective embodiments of the present invention. Part or all of processing system 100 may be implemented in one or more of the elements of environment 200.

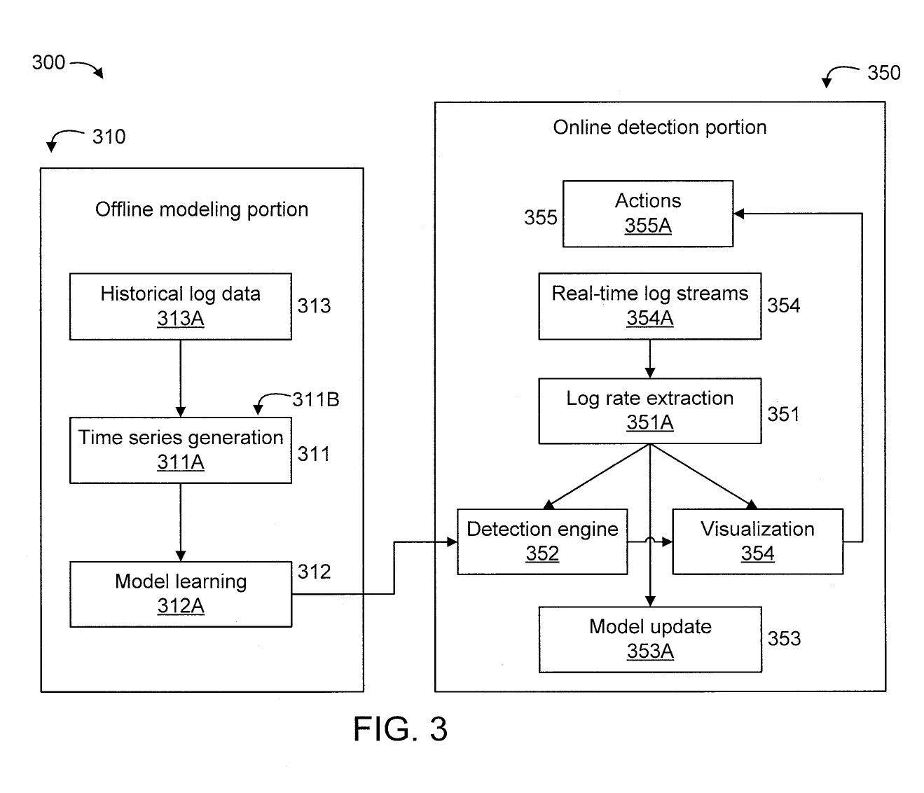

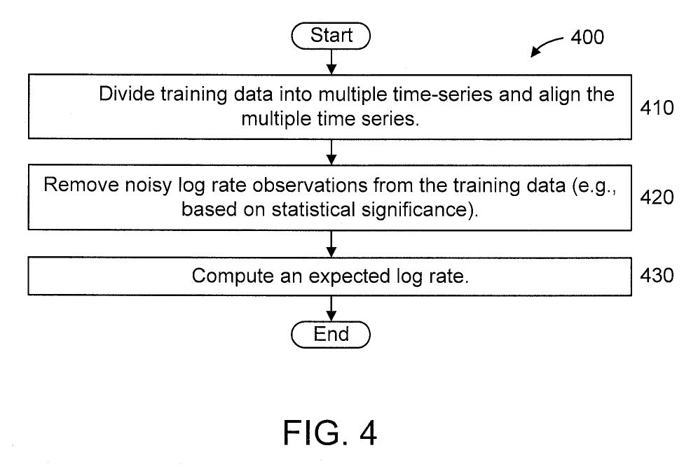

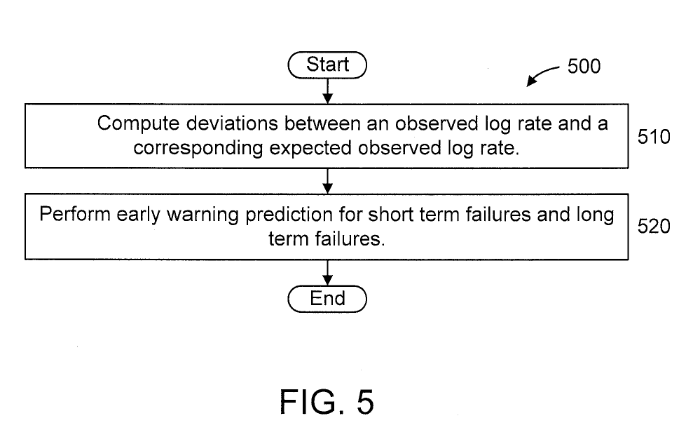

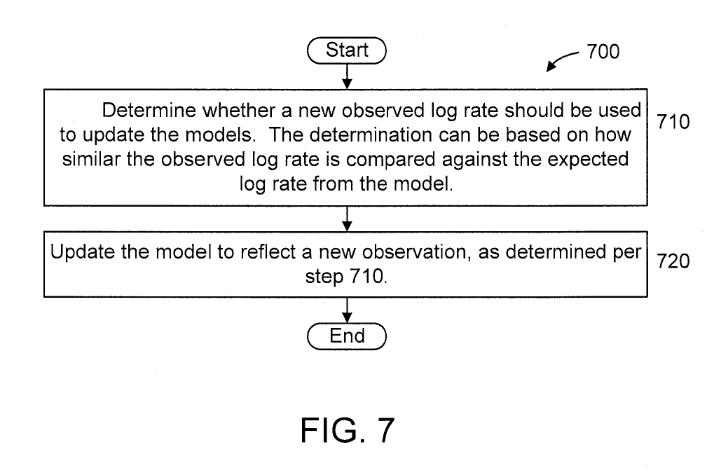

Further, it is to be appreciated that processing system 100 may perform at least part of the method described herein including, for example, at least part of method 300 of FIG. 3 and/or at least part of method 400 of FIG. 4 and/or at least part of method 500 of FIG. 5, and/or at least part of method 700 of FIG. 7. Similarly, part or all of environment 200 may be used to perform at least part of method 300 of FIG. 3 and/or at least part of method 400 of FIG. 4 and/or at least part of method 500 of FIG. 5, and/or at least part of method 700 of FIG. 7.

Also, it is to be appreciated that system 300 described below with respect to FIG. 3 is a system for implementing respective embodiments of the present invention. Part or all of processing system 100 and/or environment 200 may be implemented in one or more of the elements of system 300.

FIG. 2 is a block diagram showing an exemplary environment 200 to which the present invention can be applied, in accordance with an embodiment of the present invention.

The environment includes a computer processing system 210 and a monitored system 220.

In an embodiment, the computer processing system can be any type of processor-based system including, but not limited to, a server, a desktop, a laptop, tablets, a smart phone, a media playback device, and so forth.

In an embodiment, the monitored system 220 is an IT system. However, as noted throughout herein, the monitored system 220 can be any type of system for which an early warning prediction system can prove useful in detecting short term and long term failures.

In the embodiment shown in FIG. 2, the elements thereof are interconnected by a network(s) 201. However, in other embodiments, other types of connections can also be used. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of environment 200 are readily determined by one of ordinary skill in the art, given the teachings of the present invention provided herein, while maintaining the spirit of the present invention.

FIG. 3 is a high level block/flow diagram showing an exemplary system/method 300 for early warning prediction, in accordance with an embodiment of the present invention.

The system/method 300 includes an offline model learning portion/process (hereinafter “offline model learning portion” for the sake of brevity) 310 and an online detection portion/process (hereinafter “online detection portion” for the sake of brevity) 350.

The offline model learning portion 310 learns the normal behavior of a monitored system (e.g., monitored system 220 of FIG. 2) from historical log data 313A. The online detection portion 350 detects failures in the monitored system in advance.

The offline model learning portion 310 includes a time-series generator 311 (for time series generation 311A) and a model learner 312 (for model learning 312A). In an embodiment, the time series generator 311 and model learner 312 are implemented by a processor and one or more memories (cache, RAM, etc.). The offline model learning portion 310 can include a historical log data store 313 for receiving historical log data 313A, or can simply receive the historical log data 313A from an external source. In an embodiment, the historical log data store 313 is implemented by a memory device.

The online detection portion 350 includes a log rate extractor 351 (for log rate extraction 351A), a detection engine 352, a model updater 353 (for performing model updates 353A), and a visualization 354. In an embodiment, the log rate extractor 351, detection engine 352, and model updater 353 are implemented by a processor and one or more memories (cache, RAM, etc.). In an embodiment, the visualization is implemented by a display device. The online detection portion 350 can include a real-time log streams store 354 for storing real-time log streams 354A, or can simply receive them from an external source.

The online detection portion 350 can include an action portion 355 for taking actions 355A depending on the results of the detection engine 352. For example, the action portion 355, which can be implemented by a processor and/or so forth, can take different actions depending upon whether a short term failure or a long term failure predicted. The action can include shutting down one or more machines that will at least one of (i) likely cause the impending failure of one or more other machines, (ii) suffer the impending failure, and (iii) will be undesirably affected by the impending failure. These and other actions are readily determined by one of ordinary skill in the art, given the teachings of the present invention provided herein, while maintaining the spirit of the present invention.

The offline modeling portion 310 perform offline modeling, which is the first step and is performed before the online detection portion 350 commences operation. A main goal of the offline modeling portion 310 is to learn the normal state behavior of the monitored system that the EWPS of the present invention is analyzing. The successful execution of this step generates a model of the IT system. The model includes the expected log rate in the monitored system at different times of the day. The model information is used during the detection phase to check if an observed log rate is an indication of any upcoming failures.

The time-series generator 311 can be considered to include a pre-processor 311B. The time-series generator 311/pre-processor 311B is used to process text logs and extract time information from the text logs. We make the presumption that all the logs have embedded time information. However, we do not enforce any specific format for the text logs. The time-series generator 311/pre-processor 311B automatically extracts the time information using a huge list of time formats that the time-series generator 311/pre-processor 311B maintains. From the extracted time information, a time series is generated. A time-series is an ordered sequence of observations where each observation is associated with time information.

The model learner 312, at a high level, estimates an expected log rate (e.g., at each minute of the day). Of course, the user of the EWPS can configure it to run at a different time resolution, depending upon the implementation. The model learner 312 outputs an initial model for the log rates. This initial model for the log rates is used for detection in the online detection portion 350.

The online detection portion 350 predicts both short term and long term failures by analyzing the deviation (if any) of the log rate compared to the expected log rate estimate from the historical data (model learning in the offline modeling portion 350). The detection engine 352 keeps a running history of the deviations from the expected log rates. The detection engine 352 raises a failure signal when it detects continuous deviations from expected log rate.

The log rate extractor 351 extracts time information from the textual logs and computes log rate for further processing.

The detection engine 352 analyzes the log rate and makes a decision to raise an early warning signal, if the log rate is not as expected. The detection engine 352 uses various statistical methods to control the false alarm rate. An interface 352A can also be provided for the users of EWPS to control the false alarm detection rate.

The model updater 353 updates the model based on the new log rates that the EWPS has observed after the detection engine 352 has started working.

The visualization (display) 354 presents the early warning signals, raised by the detection engine 352, to the user of EWPS, e.g., in the form of graphs. The graphs can have specific information about the failures and also point out the time at which failure symptoms have begun.

FIG. 4 is a flow diagram showing an exemplary method 400 performed by the model updater 353 of FIG. 3, in accordance with an embodiment of the present invention.

At step 410, divide training data into multiple time-series and align the multiple time series. A presumption relating to step 410 is that the log rate at aligned times is expected to be nearly the same. In an embodiment, the user is provided control over how the training data is aligned.

At step 420, remove noisy log rate observations from the training data. In an embodiment, a log rate observation is considered noise if it is statistically significantly different from the other observations in the data. In an embodiment, non-parameterized statistical methods are used to remove such faulty observations before computing the normal log rate model from the data.

At step 430, compute an expected log rate. In an embodiment, the expected log rate is computed by computing the mean (or median, or some other metric) of the normal log rates (after removing the outliers per step 420). That is, as readily appreciated by one of ordinary skill in the art, other metrics can be used including, but not limited to, median, and so forth.

FIG. 5 is a flow diagram showing an exemplary method 500 performed by the detection engine 352 of FIG. 3, in accordance with an embodiment of the present invention.

At step 510, compute deviations between an observed log rate and a corresponding expected observed log rate. The observed log rate is the rate at which logs are being generated when the EWSP is in action. The deviation is estimated using the observed log rate and the expected log rate at that time.

At step 520, perform early warning prediction for short term failures and long term failures.

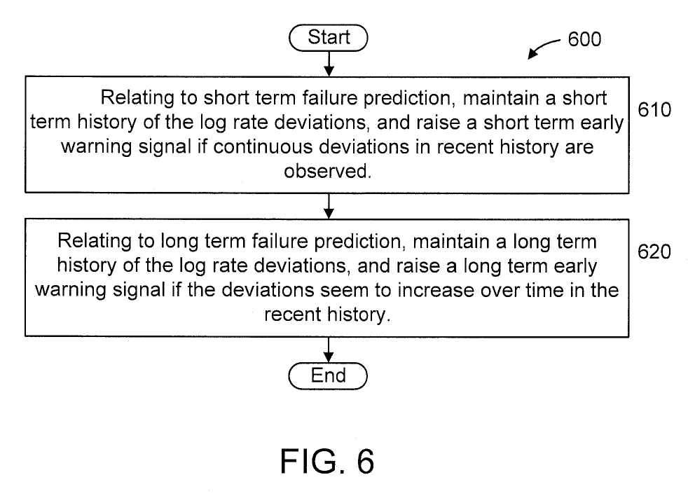

FIG. 6 is a flow diagram further showing step 520 of method 500 of FIG. 5, in accordance with an embodiment of the present invention.

At step 610, relating to short term failure prediction, maintain a short term history of the log rate deviations, and raise a short term early warning signal if continuous deviations in recent history are observed.

At step 620, relating to long term failure prediction, maintain a long term history of the log rate deviations, and raise a long term early warning signal if the deviations seem to increase over time in the recent history.

FIG. 7 is a flow diagram showing an exemplary method 700 performed by the model updater 353 of FIG. 3, in accordance with an embodiment of the present invention.

At step 710, determine whether a new observed log rate should be used to update the models. The determination is based on how similar the observed log rate is compared against the expected log rate from the model.

At step 720, update the model to reflect a new observation, as determined per step 710.

A description will now be given regarding specific competitive/commercial advantages of the solution achieved by the present invention.

One advantage is faster operation. For example, the online detection engine is based on a constant time algorithm. In other words, the execution time of the detection engine is the same irrespective of the volume of incoming log stream. This helps the system to scale very easily and handle very large systems such as huge IT systems.

Another advantage is lesser down-time for the monitored systems. For example, the present invention predicts failures well in advance. This helps the system administrators to prevent/prepare for the failures.

Yet another advantage is that the present invention is easy to incorporate. For example, the present invention is based on the aggregated log rates. Therefore, it is very easy to incorporate the present invention into any existing monitored systems such as IT systems.

Still another advantage is that the present invention aids in error diagnoses. For example, the online detection engine not only predicts failures in advance but also points out a specific time in the past where the symptoms first began to show. This feature is very helpful in finding the possible root cause(s) of the failure.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for providing an early warning of an impending failure in a monitored system, the method comprising:
performing, by a processor, an offline model learning process that generates a model of expected log rates in the monitored system from historical log data, the expected log rates of the model representing a normal behavior of the monitored system;
performing, by the processor, an online detection process that detects the impending failure in the monitored system prior to an actual occurrence of the impending failure based on (i) the model of expected log rates and (ii) observed log rates in the monitored system; and
displaying, by a display device based on (i) the model of expected log rates and (ii) observed log rates in the monitored system, information relating to the impending failure prior to the actual occurrence of the impending failure,
wherein the online detection process identifies short term failures and long term failures in the monitored system.

2. The computer-implemented method of claim 1, wherein the offline learning process comprises generating a plurality of time series from the historical log data, and wherein the model of the expected log rates of the monitored system is generated based on the plurality of time series.

3. The computer-implemented method of claim 2, wherein the model of the expected log rates of the monitored system includes the expected log rates in the monitored system for different times of a day.

4. The computer-implemented method of claim 2, further comprising updating the model based on newly observed log rates in the monitored system.

5. The computer-implemented method of claim 1, wherein the online detection process evaluates the model of expected log rates in the monitored system against the observed log rates in the monitored system to identify the impending failures.

6. The computer-implemented method of claim 1, wherein said online detection process maintains a running history of deviations between the expected log rates from the model and the observed log rates in the monitored system, and raises a failure signal when continuous deviations are detected greater than a threshold time period.

7. The computer-implemented method of claim 1, further comprising controlling a false alarm rate of the monitored system using at least one statistical based method applied to the historical log data.

8. The computer-implemented method of claim 1, further comprising controlling an operation of the monitored system based on a detection of the impending failure in order to prevent the impending failure or mitigate undesirable results of the impending failure.

9. The computer-implemented method of claim 8, wherein controlling the operation of the monitored system comprises powering down one or more machines that will at least one of (i) likely cause the impending failure of one or more other machines, (ii) suffer the impending failure, and (ii) will be undesirably affected by the impending failure.

10. The computer-implemented method of claim 1, wherein the information relating to the impending failure is displayed as one or more graphs.

11. The computer-implemented method of claim 1, wherein the information relating to the impending failure includes a time point at which failure symptoms began.

12. The computer-implemented method of claim 1, wherein the historical log data comprises historical log rate observations, and the method further comprises removing one or more of the historical log rate observations from the historical log data as being noisy based on statistical significance to other ones of the historical log rate observations, the one or more removed historical log rate observations being unconsidered by the offline model learning process in generating the model of expected log rates.

13. The computer-implemented method of claim 12, further comprising determining the statistical significance of the one or more of the historical log rate observations to the other ones of the historical log rate observations using one or more non-parameterized statistical methods.

14. The computer-implemented method of claim 1, distinguishing between short term failures and long term failures based on different time-based metrics, and wherein the information displayed in said displaying step includes an identification of which type of failure is implemented from among the short term failure and the long term failure.

15. The computer-implemented method of claim 1, wherein said displaying step comprises identifying the impending failure as a long term failure, responsive to a number of deviations, between the expected log rates from the model and the observed log rates in the monitored system, increasing over time.

16. A computer program product for providing an early warning of an impending failure in a monitored system, the computer program product comprising a non-transitory computer readable storage medium having program instructions embodied therewith, the program instructions executable by a computer to cause the computer to perform a method comprising:
performing, by a processor, an offline model learning process that generates a model of expected log rates in the monitored system from historical log data, the expected log rates of the model representing a normal behavior of the monitored system;
performing, by the processor, an online detection process that detects the impending failure in the monitored system prior to an actual occurrence of the impending failure based on (i) the model of expected log rates and (ii) observed log rates in the monitored system; and
displaying, by a display device based on (i) the model of expected log rates and (ii) observed log rates in the monitored system, information relating to the impending failure prior to the actual occurrence of the impending failure,
wherein the online detection process identifies short term failures and long term failures in the monitored system.

17. The computer program product of claim 16, wherein said online detection process maintains a running history of deviations between the expected log rates from the model and the observed log rates in the monitored system, and raises a failure signal when continuous deviations are detected greater than a threshold time period.

18. The computer program product of claim 16, wherein the method further comprises controlling an operation of the monitored system based on a detection of the impending failure in order to prevent the impending failure or mitigate undesirable results of the impending failure.

19. The computer program product of claim 18, wherein controlling the operation of the monitored system comprises powering down one or more machines that will at least one of (i) likely cause the impending failure of one or more other machines, (ii) suffer the impending failure, and (ii) will be undesirably affected by the impending failure.

20. A computer processing system for providing an early warning of an impending failure in a monitored system, the computer processing system comprising:
a processor, configured to:
perform an offline model learning process that generates a model of expected log rates in the monitored system from historical log data, the expected log rates of the model representing a normal behavior of the monitored system; and
perform an online detection process that detects the impending failure in the monitored system prior to an actual occurrence of the impending failure based on (i) the model of expected log rates and (ii) observed log rates in the monitored system; and
a display device, configured to display, based on (i) the model of expected log rates and (ii) observed log rates in the monitored system, information relating to the impending failure prior to the actual occurrence of the impending failure,
wherein the online detection process identifies short term failures and long term failures in the monitored system.
